(19) United States
(12) Patent Application Publication
(10) Pub. No.: US 2009/0008105 A1
(43) Pub. Date: Jan. 8, 2009

(54) High Flow Mobile Fire Fighting System

(75) Inventors: Ashley Arthur Price, Collegeville, PA (US); Laurence D. Seng, Blue Bell, PA (US); Fred Paldan, St. Peters, PA (US); John Vo, Blue Bell, PA (US); Hank Shaefer, Newtown Square, PA (US)

Correspondence Address: MERCHANT & GOULD PC, P.O. BOX 2903, MINNEAPOLIS, MN, 55402-0903, US

(73) Assignee: KIDDE FIRE FIGHTING, INC., EXTON, PA (US)

(21) Appl. No.: 12/055,613

(22) Filed: Mar. 26, 2008

Related U.S. Application Data
(63) Continuation of application No. 10/926,736, filed on Aug. 26, 2004, now abandoned.
(60) Provisional application No. 60/499,206, filed on Aug. 29, 2003.
(60) Provisional application No. 60/549,755, filed on Mar. 2, 2004.

(51) Int. Cl. A62C 27/00

(52) U.S. Cl. 169/52

(57) ABSTRACT

A mobile fire fighting foam delivery system. The system can include a trailer towable behind a vehicle. The trailer includes a frame with top, bottom and side surfaces, and is formed with a stabilizing ballast assembly. The trailer is mounted with an inlet that is connected with a nozzle assembly. The nozzle assembly includes a discharge nozzle device, and is structured and configured with a limited range of motion. Also included is a pump and hose system that can provide high volume flow of water and foam to the trailer in a variety of configurations. Also included is a manifold having a main body having an outlet, a plurality of inlets coupled to the main body, and at least one pressure relief valve coupled to the main body.

### RELATED APPLICATION

This application claims the benefit of U.S. Patent Provisional Application Ser. No. 60/499,206, Attorney Docket No. 13867.272USP1, filed Aug. 29, 2003, and entitled “High Flow Mobile Fire Fighting Foam Delivery Device,” and U.S. Patent Provisional Application Ser. No. 60/549,755, Attorney Docket No. 13867.272USP2, filed Mar. 2, 2004, and entitled “High Flow Mobile Fire Fighting Foam Delivery Device,” the entirety of which are hereby incorporated by reference.

### FIELD OF INVENTION

This invention is related to fire fighting foam delivery systems. More particularly, the present invention is related to fire fighting foam delivery systems that are mobile and enable delivery of foam and water mixtures at a high volume flow.

### BACKGROUND OF THE INVENTION

Mobile fire fighting devices are common and widely used for delivering foam and water mixtures to extinguish large storage tank fires, such as fuel tanks. Typically, such devices employ a trailer mounted with an inlet for receiving a flow of both water and foam concentrates pumped from outside sources. The inlet is connected with a nozzle assembly, which usually is mounted on a top surface of the trailer. The nozzle assembly is provided as a straight bore non-aspirating nozzle. The nozzle assembly can be controlled using a control panel, where the direction of flow is manually operated and where the device can be monitored. The trailer usually is provided with a wheel assembly and ball hitch for mobile attachment to a motorized vehicle. The trailer can include pivoting members that swing out from sides of the trailer to contact the ground surface in stabilizing the trailer when in use.

A water or water/foam mixture is supplied to the trailer using one or more hoses running from one or more sources. These hoses are typically connected at a first end to the source of water or water/foam mixture and at a second end to the trailer.

However, such devices typically provide limited flow capacity due to smaller sized inlet connections, and do not allow for greater volume flows that can be necessary to extinguish large storage tank fires. This limited flow capacity can reduce the distance and elevation that can be traversed between the water source and fire, as well as require larger and/or additional equipment to fight a particular fire.

While previous designs may be suitable for their intended purposes, improvements can still be made upon mobile fire fighting foam delivery systems in order to deliver greater volume flows of foam and water mixtures.

### SUMMARY OF THE INVENTION

This invention is related to fire fighting foam delivery systems. More particularly, the present invention is related to fire fighting foam delivery systems that are mobile and enable delivery of foam and water mixtures at a high volume flow.

In accordance with one aspect, the invention relates to a mobile fire fighting system including a manifold including a main body defining an outlet having a diameter of at least 12 inches, a plurality of inlets coupled to the main body, and at least one pressure relief valve coupled to the main body, wherein the plurality of inlets are coupled to at least one source of water and foam mixture. The fire fighting device also includes a pump device defining an inlet coupled to the manifold, and an outlet, wherein the pump device increases a pressure of the water and foam mixture, and a delivery device, including a stabilizing ballast including a tank configured to be filled with a predetermined mass, an inlet having a diameter of at least 12 inches coupled to the pump device, and a discharge nozzle assembly including a discharge nozzle for delivering the water and foam mixture to a fire.

In accordance with another aspect, the invention relates to a mobile fire fighting system including a manifold including a main body defining an outlet having a diameter of at least 12 inches, a plurality of inlets coupled to the main body, and at least one pressure relief valve coupled to the main body, wherein the plurality of inlets are coupled to at least one source of water and foam mixture. The fire fighting device also includes a delivery device, including a stabilizing ballast including a tank configured to be filled with a predetermined mass, an inlet having a diameter of at least 12 inches coupled to the pump device, and a discharge nozzle assembly including a discharge nozzle for delivering the water and foam mixture to a fire.

In yet another aspect, the invention relates to a mobile fire fighting foam delivery device, including a trailer towable behind a vehicle, the trailer including a frame with top, bottom and side surfaces, a stabilizing ballast assembly coupled to the frame, the stabilizing ballast assembly including a tank configured to be filled with a predetermined mass, and an inlet formed in the frame, the inlet enabling high volume flows, and the inlet being connected with a discharge nozzle assembly, the discharge nozzle assembly being coupled to the top surface of the trailer and including a discharge nozzle for delivering a water and foam mixture. The stabilizing ballast and nozzle assemblies stabilize the trailer during use and support high volume flows delivered through the inlet.

In yet another aspect, the invention relates to a mobile fire fighting foam system, including a foam supply, a first water pump coupled to the foam supply and a source of water, and a first conduit coupled at a first end to the first water pump and at a second end to a mobile fire fighting device configured to deliver water and foam to a fire. The system also includes a second water pump, a second conduit coupled at a first end to the second water pump, and a Wye connection having inlets coupled to second ends of the first and second conduits, and an outlet coupled to a third conduit coupled to the device, wherein a diameter of the first and second conduits and the inlets and outlet of the Wye connection are at least 8, 10, 12, 14 or 16 inches.

In another respect, the invention relates to a manifold for a mobile fire fighting foam delivery system, including a main body defining an outlet, a plurality of inlets coupled to the main body, and at least one pressure relief valve coupled to the main body.

In yet another respect, the invention relates to a mobile fire fighting foam delivery system, including a mobile fire fighting foam delivery device, and a manifold coupled to the delivery device. The manifold includes a main body defining an outlet, a plurality of inlets coupled to the main body, and at least one pressure relief valve coupled to the main body.

These and other various advantages and features of novelty, which characterize the invention, are pointed out in the following detailed description. For better understanding of the invention, its advantages, and the objects obtained by its use, reference should also be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 represents an elevated perspective view of one embodiment of a mobile fire fighting foam delivery device in accordance with the principles of the present invention;

FIG. 2 represents a side view of the device illustrated in FIG. 1;

FIG. 3 represents a top view of the device illustrated in FIG. 1;

FIG. 4 represents a side view of one embodiment of a mobile water pump used in one embodiment of a pump system adaptable for delivering water to the mobile fire fighting device of FIG. 1;

FIG. 5 represents a top view of the water pump of FIG. 4;

FIG. 6A represents a rear view of the water pump of FIG. 4;

FIG. 6B represents another rear view of the water pump of FIG. 4;

FIG. 7A represents a perspective view of one embodiment of a suction manifold adaptable for use with a pump system as illustrated in FIG. 4;

FIG. 7B represents a top view of the manifold of FIG. 7A;

FIG. 7C represents a side view of the manifold of FIG. 7A;

FIG. 8A represents a perspective view of one embodiment of a manifold adaptable for use with a fire fighting foam delivery system;

FIG. 8B represents a top view of the manifold of FIG. 8A;

FIG. 8C represents a side view of the manifold of FIG. 8A;

FIG. 8D represents an end view of the manifold of FIG. 8A;

FIG. 9 represents a schematic view of one embodiment for a pump system incorporating a mobile fire fighting foam delivery device in accordance with the principles of the present invention;

FIG. 10 represents a schematic view of another embodiment for a pump system incorporating a mobile fire fighting foam delivery device in accordance with the principles of the present invention;

FIG. 11 represents a schematic view of another embodiment for a pump system incorporating a mobile fire fighting foam delivery device in accordance with the principles of the present invention;

FIG. 12 represents a schematic view of another embodiment for a pump system incorporating a mobile fire fighting foam delivery device in accordance with the principles of the present invention;

FIG. 13 represents a schematic view of another embodiment for a pump system incorporating a mobile fire fighting foam delivery device in accordance with the principles of the present invention; and

FIG. 14 represents a schematic view of another embodiment for a pump system incorporating a mobile fire fighting foam delivery device in accordance with the principles of the present invention.

### DETAILED DESCRIPTION

In the following description of the illustrated embodiments, reference is made to the accompanying drawings that form a part hereof, and in which is shown by way of illustration of the embodiments in which the invention can be practiced. It is to be understood that other embodiments can be utilized as structural changes can be made without departing from the spirit and scope of the present invention.

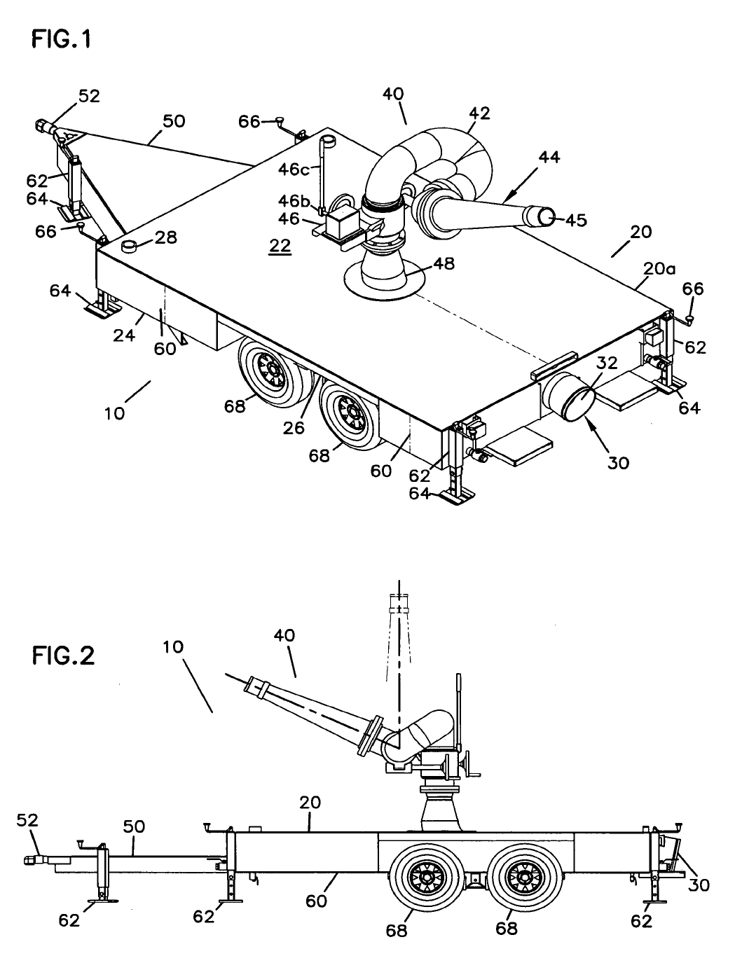

FIGS. 1-3 illustrate one embodiment of a mobile fire fighting foam delivery device 10 according to the principles of the present invention. The device 10 includes a trailer 20 that is towable behind a motorized vehicle. In one embodiment, the trailer 20 includes a hitch frame 50 that is connected at an end of a main frame 20a of the trailer 20. The hitch frame 50 is provided with a hitch portion 52 at an end opposite to which the hitch frame 50 is connected to the frame 20a. In one embodiment, the hitch portion 52 is a ball-type adaptable hitch. It will be appreciated that the hitch portion 52 can be any well known hitch structures used for towing trailers. It also will be appreciated that any structure and configuration for the hitch frame 50 can be employed as suited for towing the device 10, and is not limited to the configuration illustrated.

The frame 20a of the trailer 20 includes top, side and bottom surfaces 22, 24 and 26, respectively. In one embodiment, the frame 20a is substantially structured and configured as a box frame. The frame 20a is formed with a stabilizing ballast assembly. The stabilizing ballast assembly includes at least one tank 60 formed and built within the frame 20a. The tank 60 includes a volume filled with a predetermined mass. In one embodiment, the tank 60 is configured to hold a volume of about 700 gallons of water with a mass equivalent thereto. The tank 60 filled with water provides needed stabilizing ballast built within the frame 20a, which stabilizes the device 10 when in use.

In conditions for delivering high volume flows, for instance, as high as 8000 gallons per minute (GPM), this water ballast enables the frame 20a to be supportable of such high volume flows. It will be appreciated the dimensions of the tank 60 and the frame 20a can be modified as desired to hold a volume of water suitable for stabilizing the device 10. It also will be appreciated that the tank 60 can be filled with a mass material other than water if desired. An overflow vent 28 is provided on the top surface 22.

Further, the stabilizing ballast assembly includes a plurality of jack stands 62 mounted at sides 24 of the frame 20a and hitch frame 52. The jack stands 62 are moveably mounted at corners of the frame 20a so as to be enabled for vertical release to a ground surface. The jack stands 62 include latch release members 66 that allow ground plates 64 to contact the ground. The jack stands 62 provide leg stands that enable the trailer 20 to be substantially secured in its ground position, so that the trailer is stabilized while in use. The water filled tank 60 and/or jack stands 62 can prevent the trailer from movement during high volume flow conditions, and help maintain use of the device 10 in a safe condition.

The trailer further includes a plurality of wheel assemblies 68 mounted on sides of the frame 20a. In one embodiment, the wheel assemblies 68 include two wheel assemblies mounted in tandem. As illustrated in FIGS. 1 and 2, only one wheel from each wheel assembly 68 is shown, and it will be appreciated that a pair of wheels in each wheel assembly 68 is oppositely disposed in a manner similar to the wheel illustrated (opposite wheel not shown). The wheel assemblies 68 provide support and stability for the trailer 20 when the device 10 is being towed or deployed. In one embodiment, the wheel assemblies 68 are provided with approximately 3500 lbs axles.

An inlet 30 is mounted at one side of the trailer 20. The inlet 30 is structured and configured to receive a high volume flow of a finished water and foam mixture. It will be appreciated that the inlet 30 is compatible with a number of foam concentrates commonly used to extinguish large storage tank fires. The inlet 30 is provided with a large diameter such as, but not limited to, 8, 10, 12 and 14 inches. It will be appreciated that the inlet 30 diameter also can be 16 inches and larger. The inlet 30 is enabled for receiving high volume flows of up to about 8000 GPM or greater at a pressure of about 115 psi. It will be appreciated that the inlet can be configured to receive greater volume flows at higher pressures. In one embodiment, the inlet 30 is connected with a length of well known flexible hosing (not shown) for receiving a pressured flow of a water and foam mixture. The flexible hosing can have a length of about 25 feet, and is connected to the inlet 30 using a well known Victaulic or Storz hose connection. A 12 inch Victaulic or Storz connection is used in one embodiment, and it will be appreciated that the connection size as well as other known connection configurations can be employed.

The inlet 30 includes a flow passage 32 for transporting the received flow of water and foam. The flow passage 32 connects the inlet 30 to a discharge nozzle assembly 40. The discharge nozzle assembly 40 includes a base portion 48 connected to the top surface 22 of the trailer 20. A conduit 42 is connected at one end to the base portion 48, and is provided with a discharge nozzle 44 disposed at the opposite end. The discharge nozzle assembly 40 is provided with a control panel 46, such that a user can manually operate and monitor the device 10, while standing on the top surface 22.

The discharge nozzle assembly 40 is manually operated by a plurality of controlling handles connected to the conduit 42. In one embodiment, the discharge nozzle assembly 40 is structured and configured as a non self-educting nozzle that can provide an efficient foam stream with an expansion ratio of 6:6:1. In this configuration, the device 10 is suitable for penetrating thermal updrafts encountered during large scale fires. The use of multiple handles limits the movement of the assembly 40 to provide suitable control of the water and foam stream and maintain user safety.

In one example embodiment, the nozzle assembly 40 is equipped with a manually operated hydraulic stream pattern changer which allows the operator to select various discharge patterns from, for example, straight stream to semi-fog.

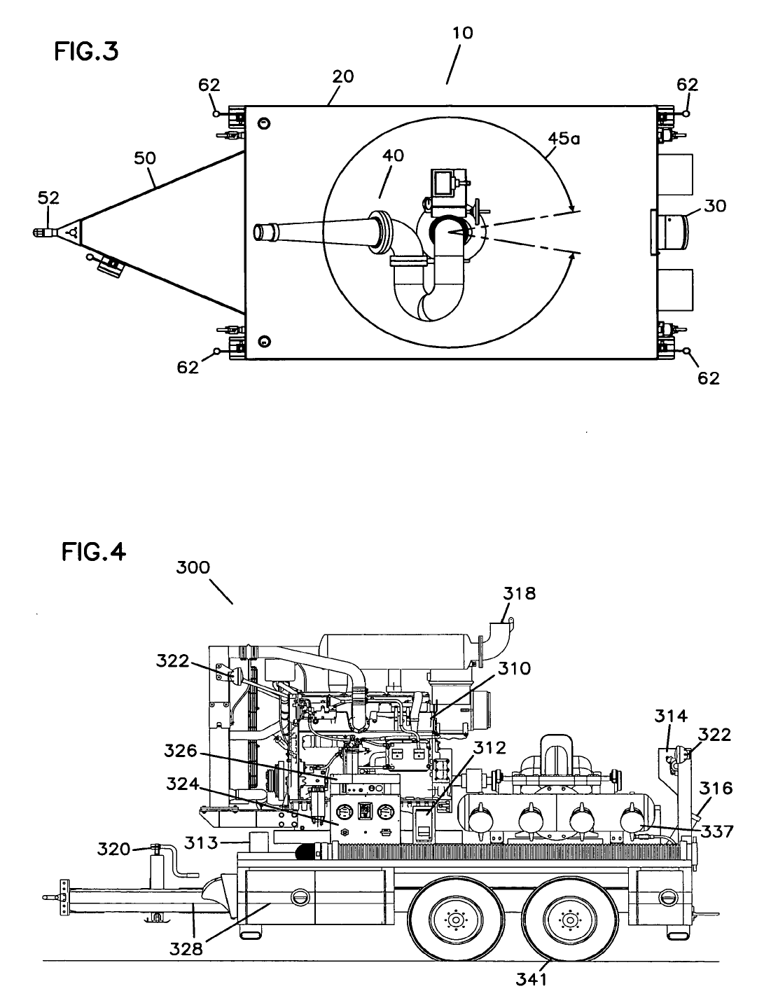

A nozzle actuating handle 46c enables the discharge nozzle assembly 40 to discharge a flow of water and foam through an outlet 45 of the nozzle 44. A rotation handle 46a enables the discharge nozzle assembly 40 to rotatably adjust about an axis from which the base portion extends. In one embodiment, the rotation handle 46a allows the discharge nozzle assembly 40 limited rotation range of about 340°. FIG. 3 illustrates the rotational range of the discharge nozzle assembly 40, and is indicated by arc 45a.

An elevation handle 46b enables the discharge nozzle assembly 40 to adjust an elevation angle of the discharge nozzle 44 relative to the plane of the top surface 22. In one embodiment, the elevation handle allows the nozzle to discharge at range of about +15° to about 90°. FIG. 2 illustrates the range of the discharge nozzle 44. In this configuration, the discharge nozzle assembly can deliver a high volume flow of water and foam in a stream having a range of about 450 feet and higher. Further, mechanical stops (not shown) can be employed at any portion of the discharge nozzle assembly, so as to further limit and confine movement of the nozzle, and provide safe working conditions.

In one embodiment, the mobile fire fighting foam delivery device 10 can be connected to a well known pump system that delivers water and foam to the inlet 30. The device 10 can be connected to a duct and manifold for commonly connecting multiple conduits that deliver both water and foam pumped from respective sources. These conduits deliver water and foam at desired pressures to the duct and the inlet 30. One duct used to achieve this is the Super Aquaduct® from Kidde Fire Fighting, Inc. Such a duct can also be connected with a manifold having an outlet to connect with the duct, and having multiple inlets for connecting the water and foam conduits. In one embodiment, the manifold includes 5 or 6 inch Victaulic or Storz connections so as to be adaptable for connecting the water and foam conduits. It will be appreciated that other sized connections and other known connection configurations can be employed if desired.

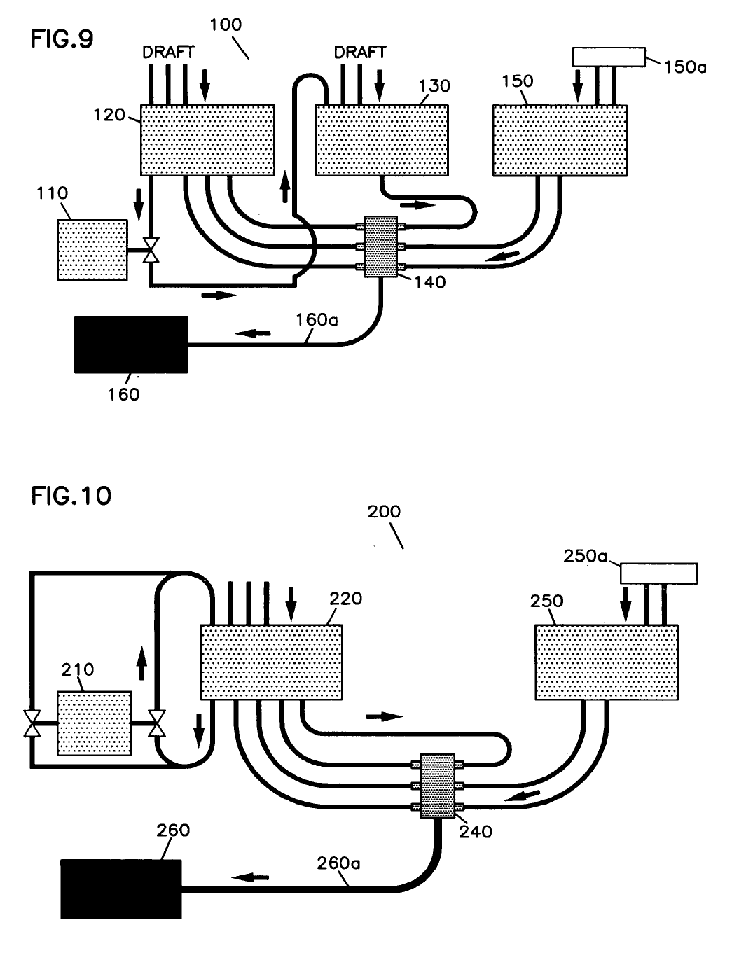

Foam is pumped from a foam source in a well known foam proportioning method using jet pumps that introduces foam to the water flow and to the device 10. In one example, a desired total flow of water and foam is about 8000 GPM. For example, a configuration of two jet pumps at 3000 GPM and one jet pump at 2000 GPM, which is used for typical foam proportioning of 3 percent or 6 percent, enables a total flow of 8000 GPM to be achieved. Example schematic configurations for such systems are illustrated in FIGS. 9-14, which are further discussed below.

FIGS. 4, 5, 6A, and 6B illustrate one embodiment of a mobile water pump 300 (sometimes referred to as a transfer or booster pump) used to deliver water to the duct and inlet 30 of the device 10. The mobile water pump 300 is portable and can be used in conditions where large volumes of water are required and a pressurized water source is not available, or where a water system is not capable of supplying adequate pressure. The water pump 300 is suitable for use with fresh or saltwater.

In one embodiment, the water pump 300 is configured to operate as high as at about 5000 GPM at 150 psi, while at a 6 foot suction lift. It will be appreciated that the water pump 300 can be configured to operate at a greater volume flow and pressure. The mobile water pump includes a trailer 340 having a box frame, where a diesel fueled engine 310 is mounted thereon. The trailer 340 is provided with a hitch for towing behind a motorized vehicle. In one embodiment, the engine is designed with a 600 HP, 2100 RPM capability. The box frame also serves as a fuel tank, having a capacity of about 300 gallons, and having a 4 inch fuel fill connection and ¾ inch fuel tank vent 317. The fuel in the fuel tank can be consumed at about 29 gallons per hour (about 110 liters) providing about a 10-hour supply.

The trailer 340 is designed to include a 14,000 GVW trailer rating, and can be conveniently utilized or removed for non-mobile or permanent applications. Wheel assemblies 341 are provided for mobility and wheel chocks 342 are employed to stabilize the water pump 300 when in use or in a storage position. The trailer 340 can also include suitable storage compartments and hose troughs. Further, a reflective strip 328 and spotlights 322 can be provided for visibility and safety. In one embodiment, a front jack 320 with a 7000 lbs rating is provided. Lifting rings 346 and folding steps 344 also are provided.

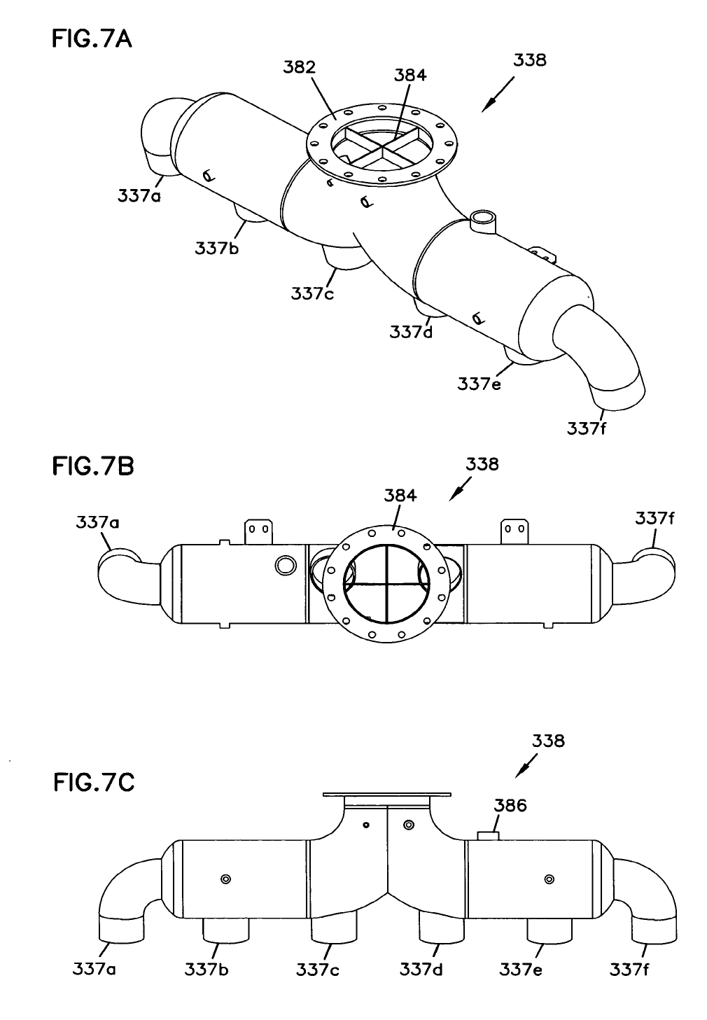

Water is delivered from a water source to suction connections 337 of a suction manifold 338 of the water pump 300 using, for example, one or more suction hoses 339 that are configured as a 6×10 foot PVC hose. The suction manifold 338 is shown in more detail in FIGS. 7A, 7B, and 7C, described below. In one embodiment, the suction connections 337 are angled down about 15° from horizontal to reduce stress on the hoses connected thereto. From the suction manifold 338, water is delivered to pump 330.

Water is then pumped by the water pump 330 through a large diameter hose connection 336 having a 10 inch Victaulic cap and discharge manifold 334. The discharge manifold 334 has a plurality of discharge connections 332 which, for example, delivers the pumped water using one or more hoses to inlet 30 of trailer 20 discussed above. The discharge connections 332 are provided as valved discharge connections. The discharge connections 332 are capped and can be configured with various sized Victaulic and/or Storz connections. In one embodiment, five 5 inch Storz connections, one 10 inch Victaulic connection and one 2.5 inch NH connection 333 are used. Larger diameter connections, such as 12, 14, 16 inches or larger, can also be used. The connection 333 is angled about 10 degrees from horizontal to reduce stress on the hose attached thereto. In one embodiment, the water pump 300 is provided with an exhaust discharge having a 6 inch industrial grade silencer 318.

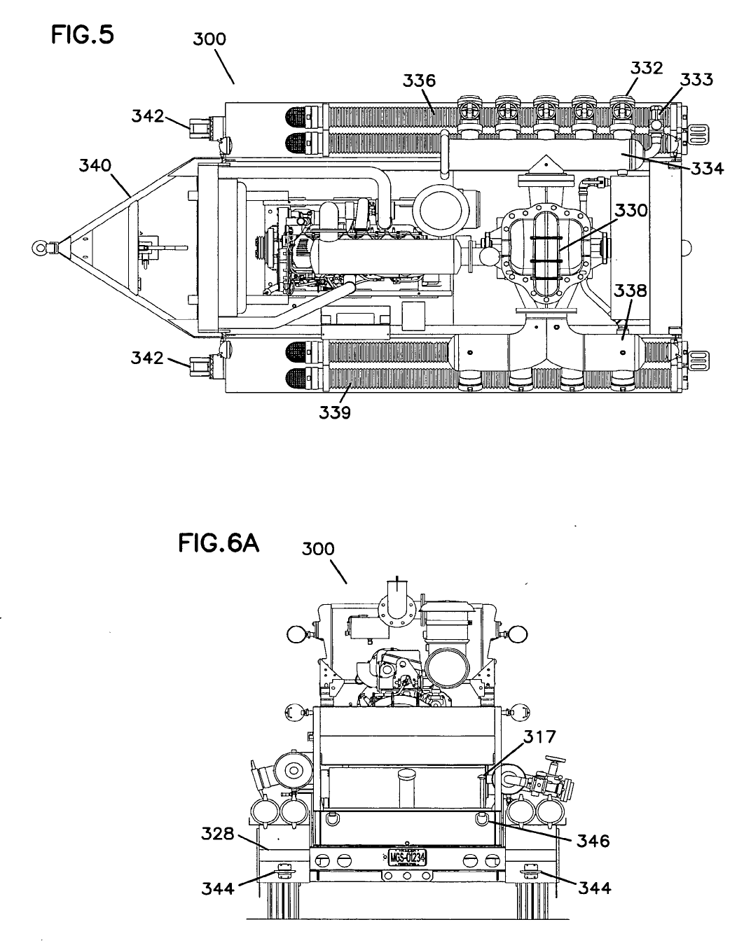

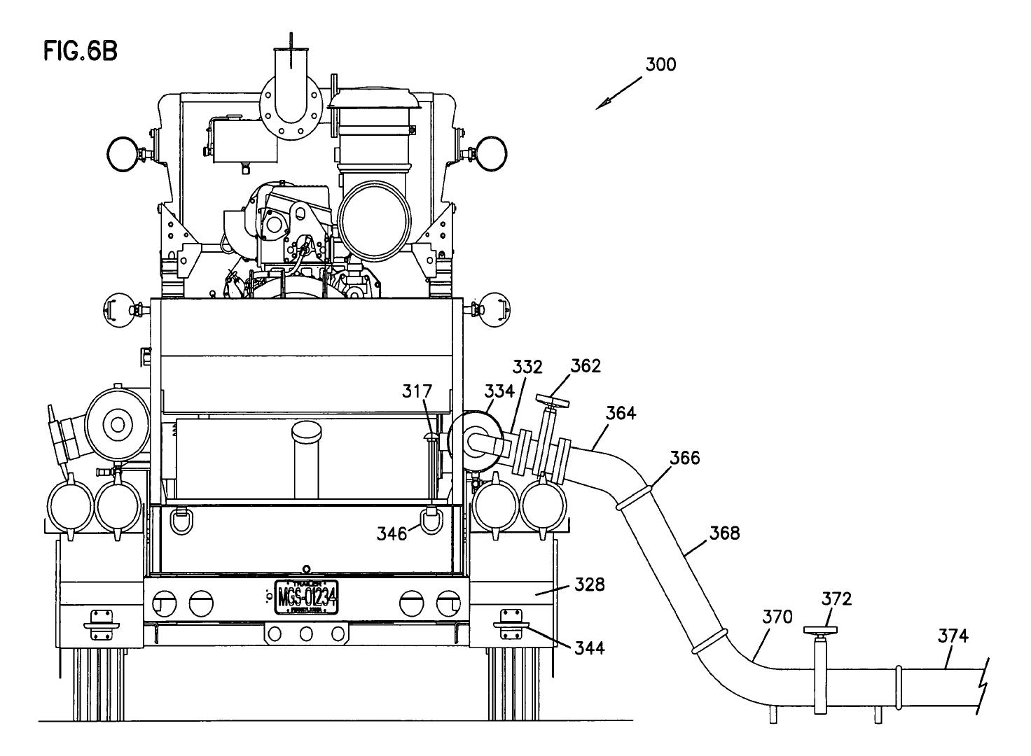

Referring specifically to FIG. 6B, hoses 374 and 368 are used to deliver water from the water pump 300 to, for example, the trailer 20. In one embodiment, hoses 374 and 368 have a diameter of 12, 14, or 16 inches or larger and are coupled by a ground discharge elbow 370 of like diameter. A pipe adapter 364 with a Victaulic or Storz connection 366 is used to couple hose 368 to one of the plurality of discharge connections 332. Shut off valves 362 and 372 are provided to start and stop the flow of water from the water pump 300 as desired.

Referring back to FIG. 4, the water pump 300 is equipped with an operator panel 326 for engine controls and manifold pressure gauges 324. The operator panel 326 provides controls necessary to start and stop the engine, monitor engine functions, prime the pump, and monitor suction and discharge pressures. In one embodiment, the operator panel is positioned so that a user can be clear of any suction or discharge. An electrical system is included, and can rely on 12 VDC with two heavy duty batteries and a 115 AMP alternator. A battery charger 312 and battery charger & engine heater connection 313 are included. The priming system 314 is provided with two 12 VDC electric primers.

As discussed above, the water pump 300 can be used with fresh water or saltwater. It will be appreciated that types of a water sources can include, but not be limited to, a portable water reservoir, a natural body of water such as a river, lake or ocean, or any established water supply (e.g., water hydrant).

The components for the mobile water pump 300 described above are illustrative only. The components can be modified as needed in providing an operating water pump under desired specifications. It will further be appreciated that the water pump 300 may not be needed in all applications. For example, pressure from foam pumps and a water source may provide sufficient pressure in some applications.

FIGS. 7A, 7B, and 7C illustrate the example suction manifold 338 in greater detail. The manifold 338 includes suction connections 337a, 337b, 337c, 337d, 337e, and 337f, although more or few connections can be provided. In one embodiment, each connection 337a, 337b, 337c, 337d, 337e, and 337f has a diameter of 6 inches and is threaded. The connections 337a, 337b, 337c, 337d, 337e, and 337f are fluidly coupled to main parts 388 of the manifold 338 having diameters of 12 inches, which are formed at right angles to one another and are welded together.

Bar vanes 384 are provided at an outlet flange 382 of the suction manifold 338 that is coupled to the water pump 300. The vanes 384 are formed at right angles and have leading and trailing edges ground to 45 degree points. The outlet flange 382 can be coupled to the water pump 300 using a variety of methods. In one embodiment, the outlet flange 382 has a 12 inch diameter and is coupled to the water pump 300 using bolts so that the manifold 338 can be removed from the water pump 300 and replaced with a different manifold as desired. This can be desirable, for example, to provide manifolds having different numbers or sizes of connections. Coupling 386 is can be used, for example, for recirculating water to keep pump 300 cool when running idle.

The suction manifold 338 can be advantageous for various reasons. For example, the configuration of the manifold 338 can provide a channeled, laminar flow of water to the pump 330 while minimizing turbulence and chop. This can be advantageous, for example, to maximize the efficiency of the pump 330.

One example method for use of the mobile fire fighting foam delivery device 10 and mobile water pump 300 is as follows. Initially, the trailer 20 is arranged so that the discharge nozzle assembly 40 is in a position to allow maximum rotational coverage of the hazard (e.g., fire). Next, any towing vehicle is removed from the trailer 20, and the jack stands 62 are deployed and adjusted to place the trailer 20 in a substantially level operating position, with the wheel assemblies 68 slightly off the ground. Level gauges can be located at each well assembly 68 and adjacent the inlet 30 to assist in leveling the trailer 20.

Next, any drain valves are closed and the tank 60 is filled with water to provide stabilization for the mobile fire fighting foam delivery device 10. In one embodiment, the tank 60 is completely filled. Next, a duct (e.g., Super Aquaduct®) is attached to the inlet 30. Next, water and foam lines are coupled to the manifold positioned at an opposite end of the duct.

Then, water and foam supplies are slowly introduced until at the desired pressure and concentration. Finally, the control handles connected to the conduit 42 of the discharge nozzle assembly 40 are operated to select a desired stream direction, trajectory, and pattern.

In example embodiments, when deactivating the mobile fire fighting foam delivery device 10, the foam supply is shut off first and water is allowed to flow until the foam has been flushed from the system and hoses.

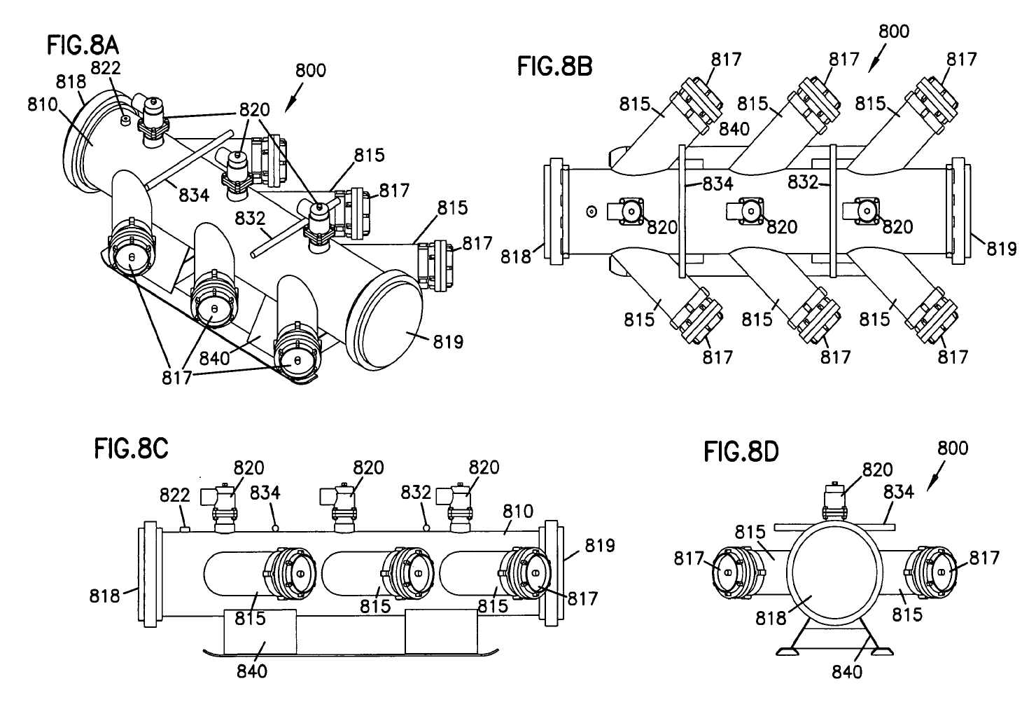

FIGS. 8A, 8B, 8C, and 8D illustrate an example manifold 800 that can be used with the mobile fire fighting foam delivery device 10 and/or mobile water pump 300 described above. Generally, the manifold 800, as described further below with reference to the systems illustrated in FIGS. 9-14 (see for example, manifolds 140, 240, 540a, and 540b illustrated therein), is used to combine water or a water/foam mixture from two or more sources into a single outlet that can be coupled, for example, to the mobile fire fighting foam delivery device 10 and/or mobile water pump 300.

The manifold 800 includes a cylindrical main body 810 with an inlet end 819 and an outlet end 818. In the illustrated example, the main body 810 is at least 12 inches in diameter, although other dimensions, such as 6, 8, 10, 14, and 16 inches, can also be used. Both the inlet and outlet ends 819, 818 each include a 12 inch Victaulic coupling and a 12 inch Victaulic coupling cap that is removed prior to use.

Extending from the main body 810 is a plurality of source inlets 815. In the illustrated embodiment, the manifold 800 includes six inlets 815, although fewer or more inlets can also be provided. Each of the inlets 815 includes a 6 inch adapter and a 5 inch Storz cap 817. In the illustrated embodiment, each of the inlets 815 extends at approximately a 45 degree angle with respect to the longitudinal axis of the main body 810. As described further below, the inlets 815 are positioned at an angle with respect to the main body 810 to provide laminar flow through the manifold 800.

Also positioned on the main body 810 are a plurality of relief valves 820 and a plug 822. In the illustrated embodiment, the main body 810 includes three relief valves 820, although more or fewer can be provided. In one embodiment, the relief valves 820 are Model No. HRV-82-S valves manufactured by Harrington, Inc. of Erie, Pa. Other types of valves can also be used. The plug 822 is a ¼ inch S/S plug. As described further below, the relief valves 820 and plug 822 are used to measure and relieve pressure in the manifold 800.

Also coupled to the main body 810 are two handles 832 and 834 that can be used to grasp and transport the manifold 800 to the desired location. A base 840 is provided below the main body 810 to stabilize and position the main body 810 relative to the surface upon which the manifold 800 is placed.

In the illustrated embodiment, the manifold 800 is made of aluminum. However, other materials can also be used such as, for example, steel.

An example method for using the manifold 800 is as follows. Preliminarily, the base 840 of the manifold 800 is placed on a surface where desired. Next, one or more of the caps 817 on the inlets 815 are removed and one or more source hoses are coupled to one or more of the inlets 815. Also, the cap at the outlet end 818 of the manifold 800 is removed and a hose coupled thereto.

Next, a water and/or a water/foam mixture is introduced by the source hoses through the inlets 815 into main body 810 of the manifold 800. The water and/or water/foam mixture from two or more inlets 815 are combined in the main body 815, and the combined flow is allowed to exit the outlet 818. Because the inlets 815 are angled with respect to the main body 810, the flow from each inlet 815 is advantageously combined to create a substantially uniform laminar flow through the outlet 818.

Should the pressure created in the main body 810 of the manifold 800 exceed a given threshold, one or more of the relief valves 820 are configured to relieve the pressure by releasing a portion of the water and/or water/foam mixture out of the main body 810. In one embodiment, the relief valves 820 are configured to relieve pressure in the main body 810 if the pressure exceeds a threshold of 175 psi, although the relief valves can be configured for different pressures. In addition, the plug 822 can be removed to allow for manual relief of pressure, as well as the insertion of a pressure gauge used to monitor the pressure in the main body 810.

In an alternative embodiment, the manifold 800 can be coupled in tandem with another manifold to provide enhanced capacity. For example, the cap at inlet 819 of the manifold 800 can be removed, and the outlet of another manifold can be coupled to the inlet 819 of the manifold 800 to create, for example, a combined manifold having twelve, rather than six, inlets.

FIGS. 9-14 illustrate system schematic views of different embodiments for a pump system incorporating a mobile fire fighting foam delivery device in accordance with the principles of the present invention.

FIG. 9 illustrates one pump system configuration 100 for a single jet pump proportioner. This arrangement is intended for a lower injection rate of up to about 3 percent. A foam concentrate is injected from a foam source 110 into a waterway discharged by a water pump 120, and is cycled back into a pump 130 for mixing prior to discharging into a manifold 140 (see, for example, manifold 800 illustrated in FIGS. 8A, 8B, 8C, and 8D). From the manifold 140, the finished mixture of water and foam is delivered to the duct 160a and fire fighting foam delivery device 160 for fighting a fire. In this embodiment, the mobile water pump 300, as discussed above, is employed as the water pump 120. An additional water pump 150 can be used to boost water intake to achieve the desired capacity and percent injection of the foam concentrate. The water pump 150 can provide water from a well-known water source 150a, such as a water hydrant or the like.

FIG. 10 illustrates one pump system configuration 200 for a dual jet pump setup. This setup is designed for a higher foam concentrate injection rate up to about 6 percent. Therefore, a dual jet pumps arrangement is used. Foam concentrate from a foam source 210 is injected into a waterway discharged by a water pump 220, and is cycled back into the water pump 210 for mixing before discharging to the manifold 240. From the manifold 240, a finished mixture of water and foam is delivered to the duct 260a and fire fighting foam delivery device 260 for fighting a fire. The mobile water pump 300, as discussed above, is employed as the water pump 220. An additional water pump 250 can be used to boost water intake into the manifold 240. The water pump 250 can provide water from a well-known water source 250a, such as a water hydrant or the like. This second water pump 250 pumps additional water into the manifold 240 to meet the required flow capacity, and in turn yields the desired percent injection of foam concentrate.

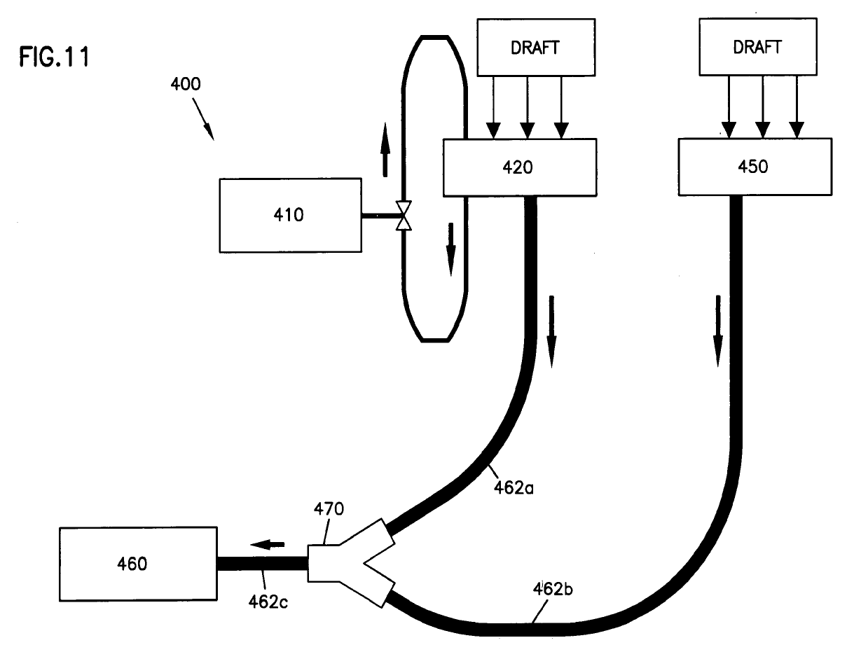

FIG. 11 illustrates another pump system configuration 400 including foam source 410 and water pumps 420 and 450. A water and foam mixture is delivered to fire fighting foam delivery device 460 through hoses 462a, 462b, and 462c. Hoses 462a, 462b, and 462c each have a diameter of 12 inches, 14 inches, 16 inches or larger. In addition, a Wye connection 470 is used to combine the flow from hoses 462a and 462b into hose 462c that is coupled to device 460. In example embodiments, the inlets and outlets of the Wye connection 470 each have a diameter of 12 inches, 14 inches, 16 inches or larger.

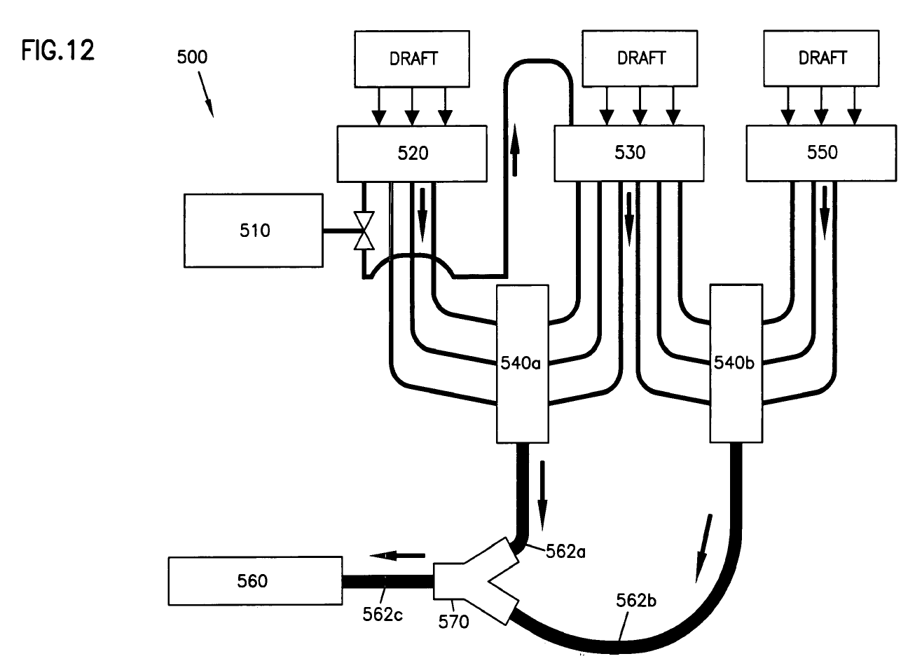

FIG. 12 illustrates another pump system configuration 500 including foam source 510 and water pumps 520, 530, and 550. A water and foam mixture is delivered to fire fighting foam delivery device 560 through manifolds 540a and 540b, and hoses 562a, 562b, and 562c. The outlets of the manifolds 540a and 540b, as well as hoses 562a, 562b, and 562c, each have a diameter of 12 inches, 14 inches, 16 inches or larger. In addition, a Wye connection 570 is used to combine the flow from hoses 562a and 562b into hose 562c that is coupled to device 560. In example embodiments, the inlets and outlets of the Wye connection 570 each have a diameter of 12 inches, 14 inches, 16 inches or larger.

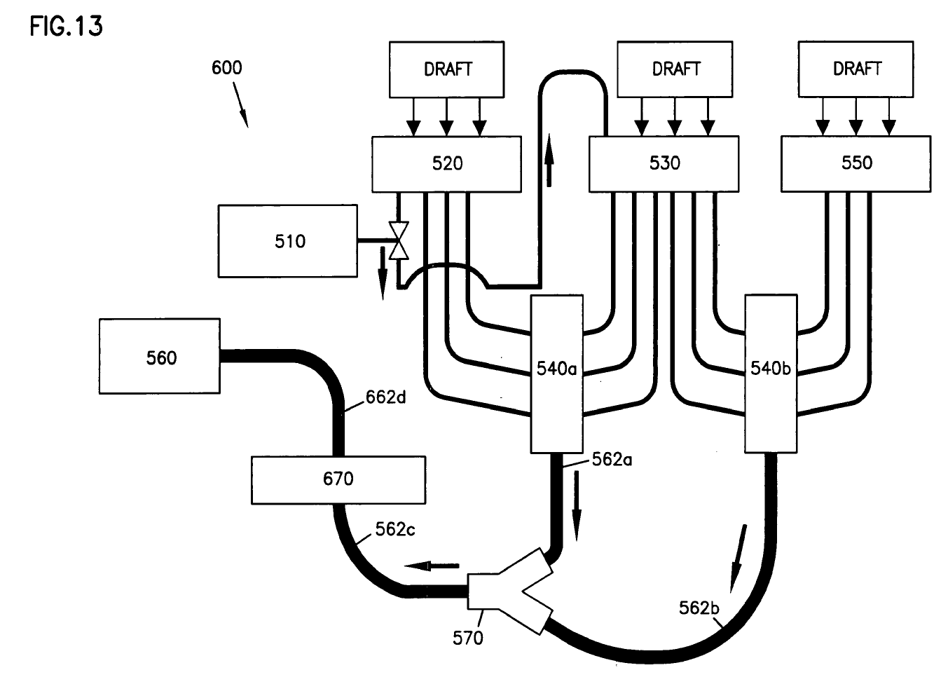

FIG. 13 illustrates another pump system configuration 600 similar to the configuration 500 illustrated in FIG. 12. However, configuration 600 includes a water pump 670 coupled to hose 562c. The water pump 670 can be used to boost pressure of the water delivered to device 560 through hose 662d.

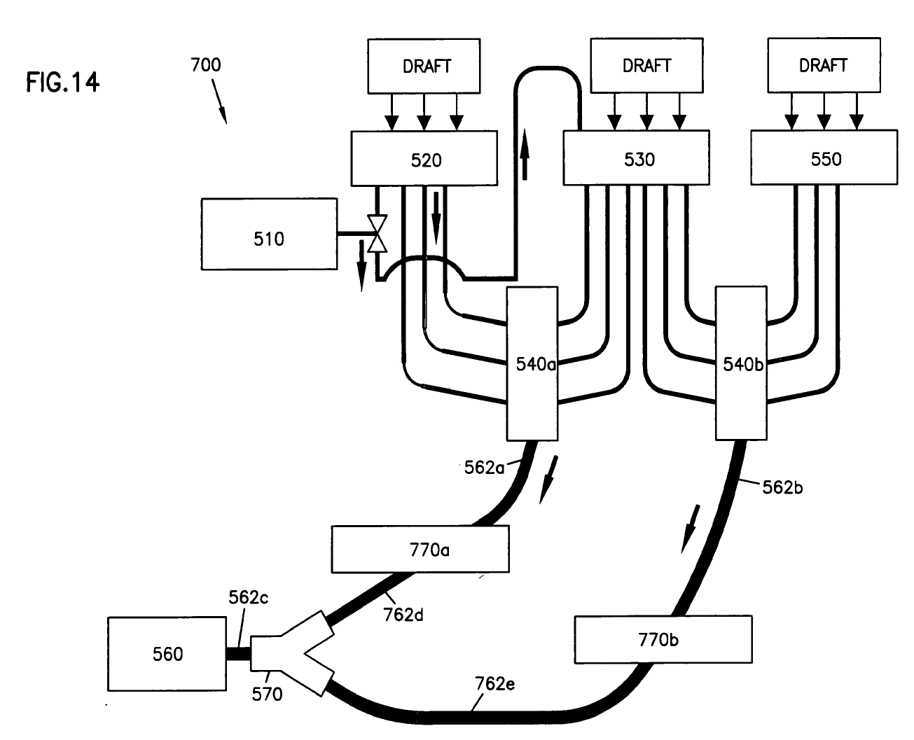

FIG. 14 illustrates another pump system configuration 700 similar to the configuration 500 illustrated in FIG. 12. However, configuration 700 includes water pumps 770a and 770b coupled to hoses 562a and 562b. The output of water pumps 770a and 770b are, in turn, provided through hoses 762d and 762e to Wye connection 570, and from hose 562c to device 560.

It can be advantageous to configure systems as illustrated in configurations 100, 200, 400, 500, 600, and 700 for various reasons. For example, configurations 400, 500, 600, and 700 can include hoses having diameters of at least 12 inches, 14 inches, 16 inches, or greater, as well as Wye connections having inlets and an outlet having diameters of at least 12 inches, 14 inches, 16 inches, or greater. This can result in a system-wide configuration with all conduits having diameters of at least 12 inches, 14 inches, 16 inches, or greater. The large diameters of these conduits allows for greater fluid flow with less frictional and resulting pressure losses.

It is therefore possible to transport water to a fire from water sources of greater distances and differing elevations. Further, in view of the larger diameter hoses and the larger diameter Wye connection allowing flow from multiple hoses to be combined, it is possible to provide greater water flow without over-pressurizing hoses. In addition, because of the increase in fluid flow, it is possible to fight larger fires with smaller and/or less fire fighting equipment.

Having described the embodiments of the present invention, modifications and equivalents can occur to one skilled in the art. It is intended that such modifications and equivalents shall be included with the scope of the invention.

1. A mobile fire fighting system, comprising:
a manifold including a main body defining an outlet having a diameter of at least 12 inches, a plurality of inlets coupled to the main body, and at least one pressure relief valve coupled to the main body, wherein the plurality of inlets are coupled to at least one source of water and foam mixture;
a pump device defining an inlet coupled to the manifold, and an outlet, wherein the pump device increases a pressure of the water and foam mixture; and
a delivery device, including:
a stabilizing system comprising:
a frame configured to stabilize and position the delivery device relative to a surface upon which the delivery device is placed during use; and
a stabilizing ballast including a tank configured to be filled with a predetermined mass;
an inlet having a diameter of at least 12 inches coupled to the pump device; and
a discharge nozzle assembly including a discharge nozzle for delivering the water and foam mixture to a fire.

2. The fire fighting system according to claim 1, wherein the manifold is coupled to the pump device by a first conduit, and the pump device is coupled to the delivery device by a second conduit, and wherein the first and second conduits each have a diameter of at least 12 inches.

3. The fire fighting system according to claim 1, wherein the delivery device can deliver a volume flow of the water and foam mixture of about 8,000 or more gallons per minute.

4. The fire fighting system according to claim 1, wherein both the pump device and the delivery device are mobile devices that are configured to be moved to a desired location.

5. (canceled)

6. The fire fighting system according to claim 1, wherein the manifold includes at least three pressure relief valves.

7. The fire fighting system according to claim 1, wherein the inlets of the manifold are positioned at approximately a 45 degree angle with respect to a longitudinal axis of the main body of the manifold.

8. A mobile fire fighting system, comprising:
a manifold including a main body defining an outlet having a diameter of at least 12 inches, a plurality of inlets coupled to the main body, and at least one pressure relief valve coupled to the main body, wherein the plurality of inlets are coupled to at least one source of water and foam mixture; and
a delivery device, including:
a stabilizing system comprising:
a frame configured to stabilize and position the delivery device relative to a surface upon which the delivery device is placed during use; and
a stabilizing ballast including a tank configured to be filled with a predetermined mass;
an inlet having a diameter of at least 12 inches coupled to the manifold; and
a discharge nozzle assembly including a discharge nozzle for delivering the water and foam mixture to a fire.

9. The fire fighting system according to claim 8, wherein the manifold is coupled to the delivery device by a conduit having a diameter of at least 12 inches.

10. The fire fighting system according to claim 8, wherein the delivery device can deliver a volume flow of the water and foam mixture of about 8,000 or more gallons per minute.

11. The fire fighting system according to claim 8, wherein the delivery device is a mobile device that is configured to be moved to a desired location.

12. (canceled)

13. The fire fighting system according to claim 8, wherein the manifold includes at least three pressure relief valves.

14. The fire fighting system according to claim 8, wherein the inlets of the manifold are positioned at approximately a 45 degree angle with respect to a longitudinal axis of the main body of the manifold.

15.-18. (canceled)

19. A manifold for a mobile fire fighting foam delivery system, comprising:
a main body defining an outlet;
a handle coupled to the main body that allows the manifold to be transported to a desired location, the handle including members, coupled to the main body, that extend in a direction transverse to that of a longitudinal axis of the main body;
a base coupled to the main body configured to stabilize and position the main body relative to a surface upon which the manifold is placed during use;
a plurality of inlets coupled to the main body; and
at least one pressure relief valve coupled to the main body.

20. The manifold of claim 19, wherein a diameter of the outlet of the main body is at least 12 inches.

21. The manifold of claim 19, wherein the inlets are positioned at approximately a 45 degree angle with respect to the longitudinal axis of the main body.

22. (canceled)

23. (canceled)
